(19) United States
(12) Patent Application Publication
(10) Pub. No.: US 2026/0364960 A1
(43) Pub. Date: Nov. 19, 2026

(54) PRINTING DEVICE

(71) Applicant: SEIKO EPSON CORPORATION, Tokyo (JP)

(72) Inventors: Hirotaka YASHIRO, MATSUMOTO-SHI (JP); Eiji MIYASHITA, MATSUMOTO-SHI (JP); Masaru JINGUSHI, AZUMINO-SHI (JP); Hiroyuki SANTO, MATSUMOTO-SHI (JP)

(21) Appl. No.: 19/675,662

(22) Filed: May 13, 2026

(30) Foreign Application Priority Data
May 16, 2025 (JP) 2025-082717

(51) Int. Cl. B41J 11/00; B41J 15/04; B41J 3/407

(52) U.S. Cl. CPC B41J 11/0095; B41J 11/0005; B41J 15/048; B41J 3/4078

(57) ABSTRACT

A printing device includes a medium support section, a printing section, a print support section, and a drive section that relatively moves the medium support section and the print support section in a first direction, a first movement section that is movable in a third direction according to a height of an upper surface of the medium, a second movement section that is movable in the third direction according to the height of the upper surface of the medium, and a first detection section that detects movement of at least one of the first movement section and the second movement section. The first movement section and the second movement section are connected such that one of the first movement section and the second movement section moves in conjunction with movement in the third direction of an other of the first movement section and the second movement section.

The present application is based on, and claims priority from JP Application Serial Number 2025-082717, filed May 16, 2025, the disclosure of which is hereby incorporated by reference herein in its entirety.

### BACKGROUND

### 1. Technical Field

The present disclosure relates to a printing device.

### 2. Related Art

In the related art, in a liquid ejecting device that ejects liquid onto a medium that is transported by being attached to a transport belt having an adhesive layer on a surface thereof, the medium lifting up due to the medium curling up or the like is detected, and in a case where the medium has risen up, the lifting up is resolved.

JP-A-2015-157269 discloses a technique in which a set of two sensors 29A and 29B is provided in a lifting-up inspection region 12 at a position upstream of a liquid ejection region 11, the occurrence of rising up U of the medium M is confirmed by the sensor 29A, and it is confirmed by the sensor 29B whether or not the rising up U of the medium M has been eliminated by a flattening section 5.

In the related art, there is a problem in that it is not possible to detect that the medium has risen up in the liquid ejection region at the downstream position from the flattening section.

### SUMMARY

According to an aspect of the present disclosure, a printing device includes a medium support section that supports a medium; a printing section that performs printing on an upper surface of the medium supported by the medium support section; a print support section that supports the printing section; and a drive section that relatively moves the medium support section and the print support section in a first direction; assuming a direction intersecting the first direction is a second direction and a direction intersecting the first direction and the second direction is a third direction, a first movement section that is installed along the second direction at one end of the print support section in the first direction and that is movable in the third direction according to a height of an upper surface of the medium at an installation position; a second movement section that is installed along the first direction at one end of the print support section in the second direction and that is movable in the third direction according to the height of the upper surface of the medium at the installation position; and a first detection section that detects movement of at least one of the first movement section and the second movement section in the third direction, wherein the first movement section and the second movement section are connected such that one of the first movement section and the second movement section moves in conjunction with movement in the third direction of an other of the first movement section and the second movement section.

### BRIEF DESCRIPTION OF THE DRAWINGS

FIG. 1 is a schematic configuration diagram of a printer according to an embodiment.

FIG. 2 is an external perspective view of a carriage.

FIG. 3 is an enlarged view of a portion A of FIG. 2.

FIG. 4 is a side view of the portion A of FIG. 2.

FIG. 5 is a front view of a coupling section between a fourth movement member and a third movement member.

FIG. 6 is a perspective view of a coupling section between the fourth movement member and the third movement member.

FIG. 7 is a perspective view of a coupling section between a second movement member and the third movement member.

FIG. 8 is a perspective view of a coupling section between the second movement member and the third movement member.

FIG. 9 is an enlarged view of a portion B of FIG. 3.

FIG. 10 is a schematic diagram of a movement section and a detection section of the printer according to the embodiment.

FIG. 11 is a schematic diagram of a movement section and a detection section of a printer according to a first modification.

FIG. 12 is a schematic diagram of a movement section and a detection section of a printer according to a second modification.

FIG. 13 is a schematic diagram of a movement section and a detection section of a printer according to a third modification.

FIG. 14 is a schematic diagram of a movement section and a detection section of a printer according to a fourth modification.

FIG. 15 is a schematic diagram of a movement section and a detection section of a printer according to a fifth modification.

FIG. 16 is a schematic diagram of a movement section and a detection section of a printer according to a sixth modification.

### DESCRIPTION OF EMBODIMENTS

Hereinafter, embodiments according to the present disclosure will be described in detail with reference to the drawings. However, unnecessarily detailed description may be omitted. For example, detailed description of already well-known matters or redundant description of substantially the same configuration may be omitted.

In the description of the present disclosure, general abbreviations may be used. For example, CPU is an abbreviation for Central Processing Unit. MPU is an abbreviation for Micro Processing Unit. ROM is an abbreviation for Read Only Memory. RAM is an abbreviation for Random Access Memory.

### Overview of Printer

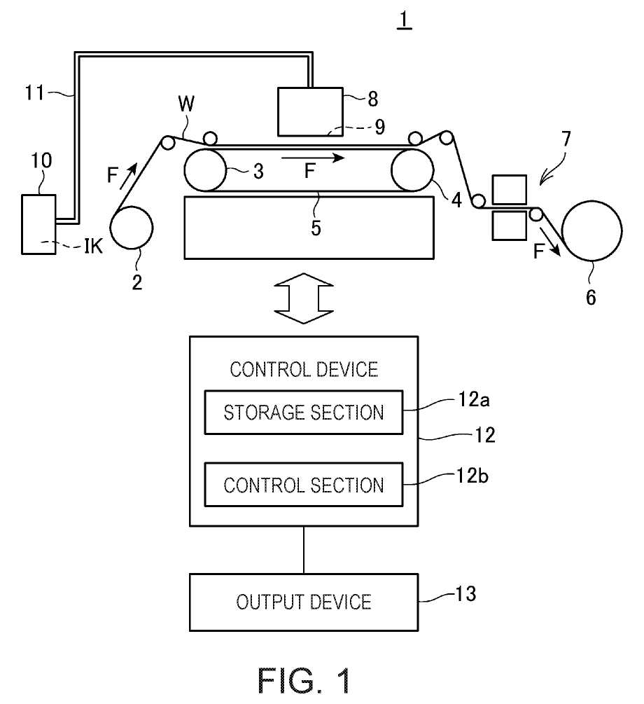

FIG. 1 is a schematic configuration diagram of a printer according to an embodiment. As illustrated in FIG. 1, the printer 1 is an ink jet type printer device that includes a print head 9 for ejecting ink IK and that forms an image by ejecting the ink IK onto a medium W. Note that in the description of the present disclosure, the ink jet type printer 1 is illustrated as an example of the printing device, but the printing method of the printing device is not limited to the ink jet type. For example, the printer 1 may be a sublimation type printer device that forms an image on the medium W by sublimating the ink IK by applying heat.

The medium W is, for example, a fabric made of natural fibers or synthetic fibers. The printer 1 is a textile printing machine that performs textile printing of a medium W by causing ink IK to adhere to the medium W, which is a fabric, and the medium W can be referred to as a material to be printed on. As the medium W, in addition to such a textile printing material, it is also possible to use special paper for ink jet recording such as plain paper, woodfree paper, and glossy paper.

The printer 1 includes a feeding device 2, transport rollers 3 and 4, a transport belt 5, and a winding device 6 that transport the medium W. These components constitute a transport mechanism for transporting the medium W. The printer 1 includes a print head 9 and an ink cartridge 10 that stores ink IK used in the print head 9.

The feeding device 2 is a device that feeds the medium W, which is elongated and wound in a roll shape, and is located on the most upstream side in a transport path of the medium W. The transport rollers 3 and 4 are a pair of rollers that drive the transport belt 5 having an endless shape. For example, the transport roller 3 is a driving roller, and the transport roller 4 is a driven roller. The transport belt 5 is a glue belt having an adhesive layer having adhesiveness formed on the surface thereof. The medium W fed from the feeding device 2 is adhesively fixed and supported on the adhesive layer of the transport belt 5, and is transported in the transport direction F together with the transport belt 5. The transport direction F is an example of a first direction.

The transport belt 5 transports the medium W in the transport direction F and supports the medium W at a position facing the print head 9. The transport belt 5 is an example of a medium support section that supports the medium W. The transport rollers 3 and 4 are an example of a drive section that relatively moves the transport belt 5 and the carriage 8 in the transport direction F. Note that the configuration in which the transport belt 5 and the carriage 8 are relatively moved in the transport direction F may be a configuration in which the carriage 8 side is moved in the transport direction F via a stepping motor or the like.

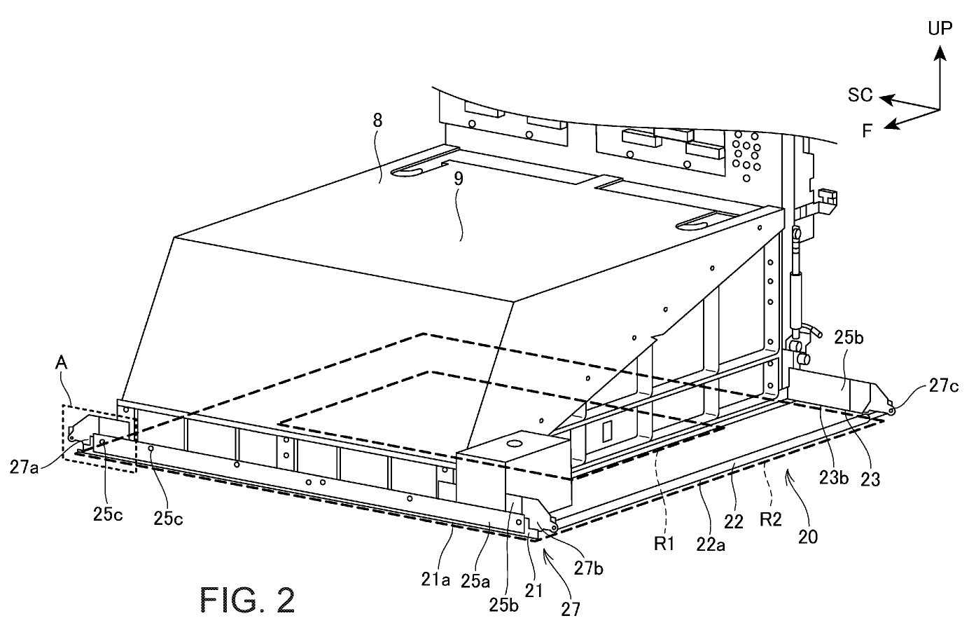

The print head 9 is mounted on the carriage 8 and is supported by the carriage 8 above the medium W supported by the transport belt 5. The carriage 8 reciprocates over the medium W in a main scanning direction SC, which intersects the transport direction F at a right angle. The main scanning direction SC is, for example, as shown in FIG. 2. The main scanning direction SC is an example of a second direction. Note that the configuration in which the transport belt 5 and the carriage 8 are relatively moved in the main scanning direction SC may be a configuration in which the transport belt 5 side is moved in the main scanning direction SC via a stepping motor or the like.

The print head 9 is connected to an ink cartridge 10 by an ink supply path 11. The printer 1 performs printing on the medium W by ejecting the ink IK from the print head 9 when the carriage 8 is reciprocated in the main scanning direction SC under the control of a control device 12. That is, the print head 9 is an example of a printing section, and the carriage 8 is an example of a print support section.

The printer 1 can perform color printing using a plurality of colors of ink IK, and for example, four colors of ink IK of black (K), cyan (C), magenta (M), and yellow (Y) are used. The printer 1 may be configured to use ink IK of a special color such as a metallic color. The printer 1 is equipped with an ink cartridge 10 for each color of the ink IK, and the print head 9 includes a nozzle corresponding to each color of the ink IK and ejects the ink IK from the nozzles.

The print head 9 may be configured to eject a penetrant liquid onto the medium W in addition to the ink IK. A penetrant is a liquid that promotes penetration of the ink IK that adheres to the front surface of the medium W into the back surface. For example, in the printer 1, a cartridge storing the penetrant liquid separately from the ink cartridge 10 may be connected to the print head 9. In this case, the print head 9 ejects the penetrant toward the medium W together with the ejection of the ink IK or at a timing different from the ejection of the ink IK.

The winding device 6 is located downstream of the transport path of the medium W, and peels off the medium W that was printed on by the print head 9 from the transport belt 5 and then winds the medium W around a winding reel.

The drying section 7 is disposed upstream of the winding device 6. The drying section 7 is located between the print position of the print head 9 and the winding device 6, and dries the ink IK adhering to the medium W. The drying section 7 includes, for example, a chamber that accommodates the medium W and a heater disposed inside the chamber. The drying section 7 dries the ink IK that is in an undried state on the medium W by heat of the heater.

In the configuration of FIG. 1, a tensioner, an intermediate transport roller, or both may be disposed between the feeding device 2 and the transport roller 3 and between the transport roller 4 and the winding device 6. The tensioner applies tension by, for example, using a roller to press the medium W being transported. The intermediate transport roller transports the medium W using, for example, a pair of rollers that sandwich the medium W.

The printer 1 includes the control device 12 and an output device 13. The control device 12 is a device that controls the operation of the printer 1 and includes a storage section 12a and a control section 12b. The output device 13 is a device that outputs various types of information to the user by voice, by display, or both under the control of the control device 12. For example, under the control of the control device 12, the output device 13 notifies the user, by voice or display, of alert information based on the detection result of the detection section 27. The detection section 27 is, for example, as shown in FIG. 2. That is, the output device 13 is an example of a notification section.

The storage section 12a includes, for example, a nonvolatile memory such as a ROM and a volatile memory such as a RAM. The nonvolatile memory of the storage section 12a stores, for example, a program executed by the control section 12b. The volatile memory of the storage section 12a is used as a work area when the control section 12b executes a program, for example. The control section 12b is a processor such as a CPU or an MPU, and controls the operation of the printer 1 by sequentially executing programs stored in the storage section 12a.

### Configuration of carriage

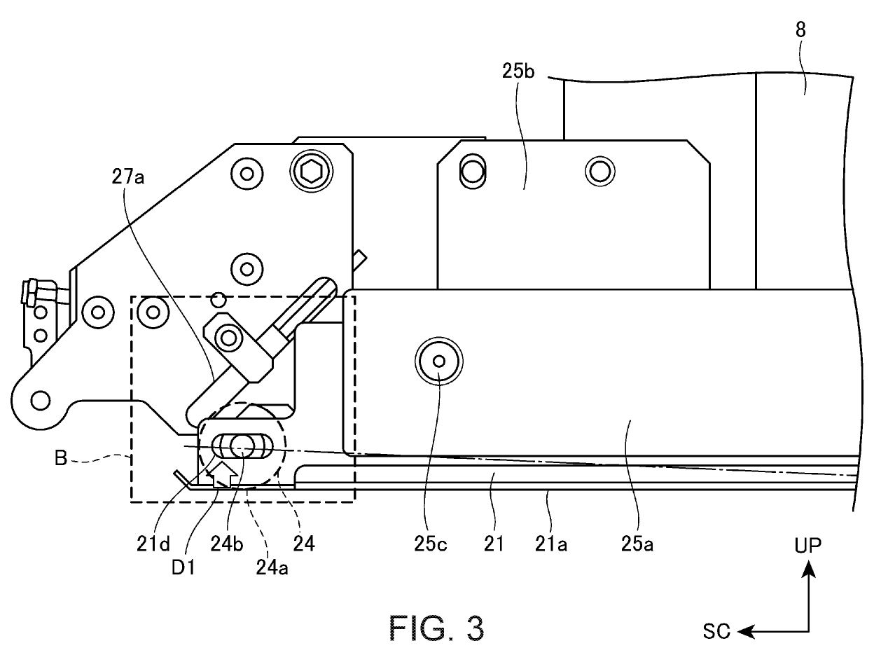

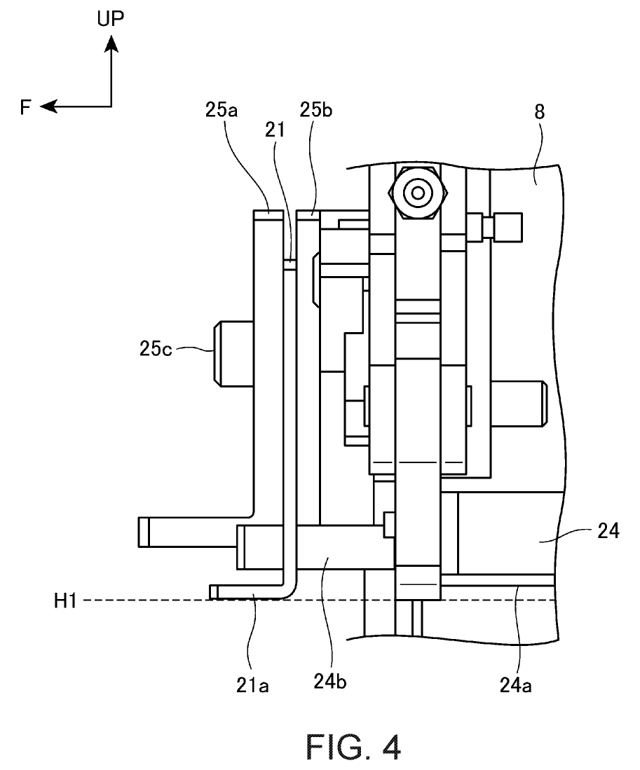

Here, configuration of the carriage 8 will be described in detail with reference to FIGS. 2-9. FIG. 2 is an external perspective view of the carriage 8. Specifically, FIG. 2 is a view of the carriage 8 as viewed from obliquely above on the downstream side in the transport direction F. FIG. 3 is an enlarged view of a portion A of FIG. 2. FIG. 4 is a side view of the portion A of FIG. 2.

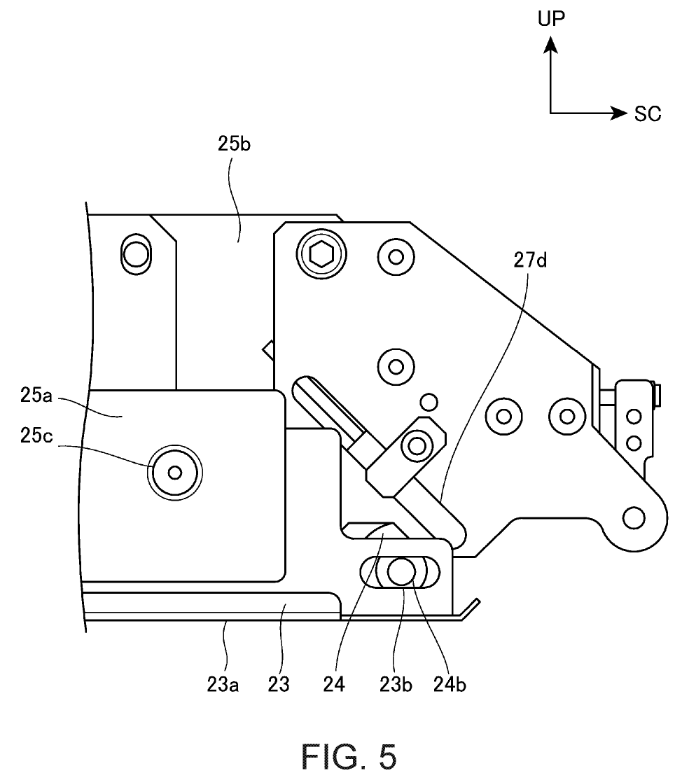

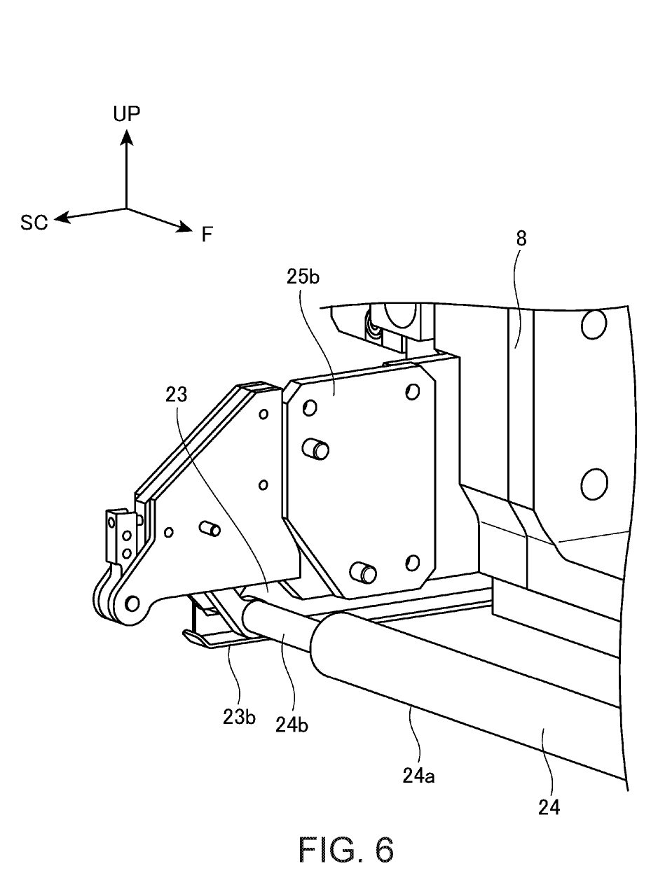

FIG. 5 is a front view of a coupling section between a fourth movement member 24 and a third movement member 23. Specifically, FIG. 5 is a view of the coupling section between the fourth movement member 24 and the third movement member 23 as viewed from the front on the upstream side in the transport direction F. FIG. 6 is a perspective view of the coupling section between the fourth movement member 24 and the third movement member 23. Specifically, FIG. 6 is a view of the coupling section between the fourth movement member 24 and the third movement member 23 as viewed obliquely from above on the downstream side in the transport direction F.

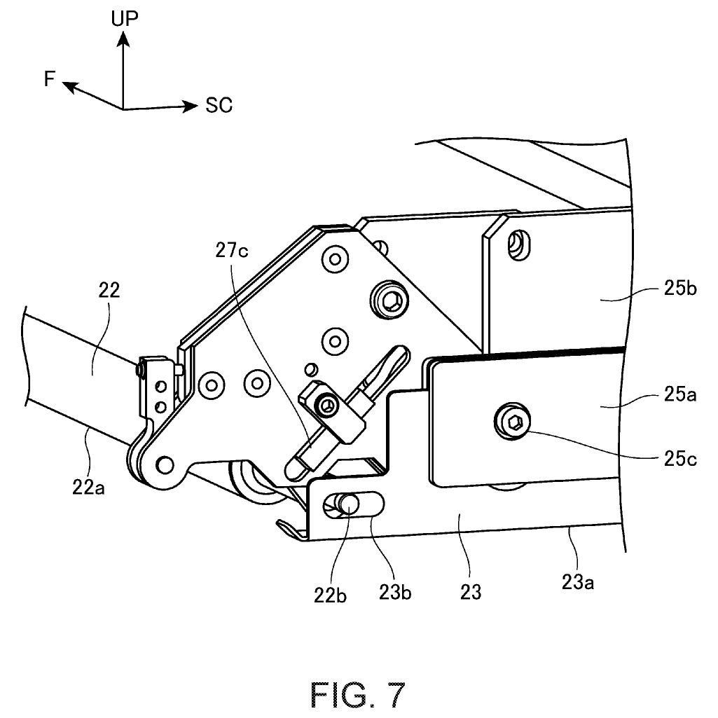

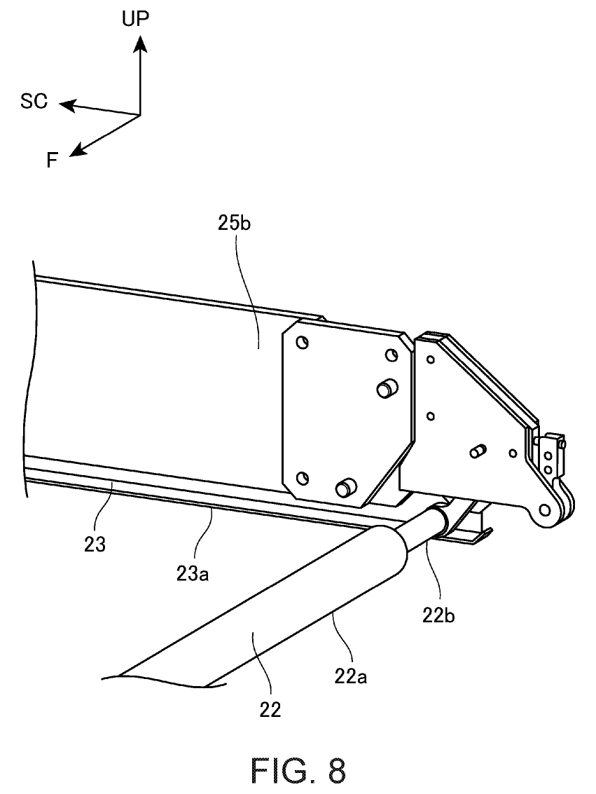

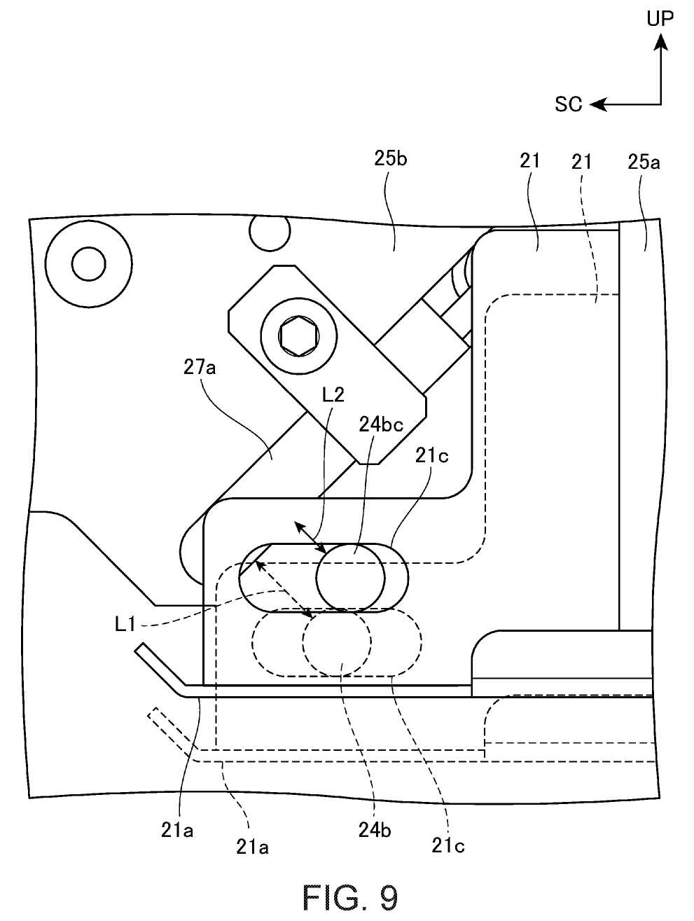

FIG. 7 is a perspective view of the coupling section between a second movement member 22 and the third movement member 23. Specifically, FIG. 7 is a view of the coupling section between the second movement member 22 and the third movement member 23 as viewed obliquely from above on the upstream side in the transport direction F. FIG. 8 is a perspective view of the coupling section between the second movement member 22 and the third movement member 23. Specifically, FIG. 8 is a view of the coupling section between the second movement member 22 and the third movement member 23 as viewed obliquely from above on the downstream side in the transport direction F. FIG. 9 is an enlarged view of a portion B in FIG. 3.

As illustrated in FIG. 2, the carriage 8 accommodates the print head 9 therein. The print head 9 housed in the carriage 8 prints on the medium W supported on the upper surface of the transport belt 5 at the print position R1, which is on the lower surface of the carriage 8.

A movement section 20 is installed in the carriage 8 so as to surround the print position R1 in a square shape. The movement section 20 is a member that is movable in the vertical direction UP according to the height of the upper surface of the medium W with respect to an installation position. The carriage 8 is provided with a detection section 27 that detects the movement of the movement section 20 in the vertical direction UP. That is, the printer 1 is configured to use the movement section 20, which is installed so as to surround the print position R1 of the carriage 8, as a detection position R2 to be able to detect lifting up of the medium W due to curling of the medium W or the like. The vertical direction UP is an example of a third direction.

Specifically, the movement section 20 includes a first movement member 21, the second movement member 22, the third movement member 23, and the fourth movement member 24. As illustrated in FIGS. 2-4, the first movement member 21 is a plate member installed along the main scanning direction SC at the end section of the carriage 8 that is on the downstream side with respect to the transport direction F.

A first support member 25a and a second support member 25b, which are a pair of plate members extending in the main scanning direction SC, are provided at an end section of the carriage 8 that is on the downstream side with respect to the transport direction F. The first support member 25a and the second support member 25b are installed at the end section of the carriage 8 by a fastening member 25c such as a screw so that the first movement member 21 is interposed therebetween. Therefore, the first movement member 21 is installed between the first support member 25a and the second support member 25b so as to be movable in the vertical direction UP.

As illustrated in FIG. 3, the first movement member 21 generates a movement D1 in the vertical direction UP when the bottom section 21a of the first movement member 21 comes into contact with the upper surface of the medium W. By this, the bottom section 21a of the first movement member 21 is lifted to a position indicated by single dot chain line, for example. The amount of movement of the bottom section 21a in the vertical direction UP corresponds to the height of the upper surface of the medium W at the installation position of the first movement member 21.

As illustrated in FIGS. 2 and 5-8, the third movement member 23 is a plate member installed along the main scanning direction SC at an end section on the upstream side of the carriage 8 in the transport direction F. That is, the first movement member 21 and the third movement member 23 are disposed so as to sandwich the carriage 8 on the upstream side and the downstream side with respect to the transport direction F.

Similarly to the first movement member 21, the third movement member 23 is installed sandwiched between the first support member 25a and the second support member 25b so as to be movable in the vertical direction UP. Therefore, the third movement member 23 moves according to the height of the upper surface of the medium W at the installation position of the third movement member 23 by the bottom section 23a of the third movement member 23 coming into contact with the upper surface of the medium W.

As illustrated in FIGS. 2, 7, and 8, the second movement member 22 is a columnar bar member installed along the transport direction F at an end section of the carriage 8 on the upstream side in the main scanning direction SC. The second movement member 22 has an end section 22b at both ends in the transport direction F that are connected to the first movement member 21 and to the third movement member 23. To be specific, the end section 22b of the second movement member 22 on the downstream side in the transport direction F is connected to the end of the first movement member 21 on the upstream side in the main scanning direction SC. The end section 22b of the second movement member 22 on the upstream side in the transport direction F is connected to an end section of the third movement member 23 on the upstream side in the main scanning direction SC. Since both the first movement member 21 and the third movement member 23 are movable in the vertical direction UP, the second movement member 22, which is connected to the first movement member 21 and to the third movement member 23, is also movable in the vertical direction UP.

The second movement member 22 is moved according to the height of the upper surface of the medium W at the installation position of the second movement member 22 by the bottom section 22a of the second movement member 22 coming into contact with the upper surface of the medium W.

As illustrated in FIGS. 7 and 8, the end section 22b of the second movement member 22 is connected to a hole section 23b, which is provided in the end of the third movement member 23, in such a manner as to be inserted into the hole center. The hole section 23b has a shape that spreads in the main scanning direction SC. Therefore, the connection position between the second movement member 22 and the third movement member 23 can be slightly moved in the main scanning direction SC in accordance with the shape of the hole section 23b. Therefore, in a case where the third movement member 23 is lifted obliquely, the second movement member 22 and the third movement member 23 can be smoothly connected by shifting the connection position between the second movement member 22 and the third movement member 23 in the main scanning direction SC. Note that the connection configuration between the second movement member 22 and the first movement member 21 is the same as that between the second movement member 22 and the third movement member 23.

As illustrated in FIGS. 2-6, the fourth movement member 24 is a columnar rod member installed along the transport direction F at the end section of the carriage 8 on the downstream side in the main scanning direction SC. End sections 24bat both ends of the fourth movement member 24 in the transport direction F are connected to the first movement member 21 and the third movement member 23. To be specific, the end section 24b of the fourth movement member 24 on the downstream side in the transport direction F is connected to the end of the first movement member 21 on the downstream side in the main scanning direction SC. In the printer 14, the end section 24b on the upstream side in the transport direction F is connected to an end section of the third movement member 23 on the downstream side in the main scanning direction SC. Since both the first movement member 21 and the third movement member 23 are movable in the vertical direction UP, the fourth movement member 24, which is connected to the first movement member 21 and the third movement member 23, is also movable in the vertical direction UP.

The fourth movement member 24 is moved according to the height of the upper surface of the medium W at the installation position of the fourth movement member 24 by the bottom section 24a of the fourth movement member 24 coming into contact with the upper surface of the medium W.

As illustrated in FIGS. 3 and 9, the end section 24b of the fourth movement member 24 is connected to the end of the first movement member 21 by being inserted into a hole section 21b provided in the end of the first movement member 21. The hole section 21b has a shape that spreads in the main scanning direction SC. Therefore, the connection position between the fourth movement member 24 and the first movement member 21 can be slightly moved in the main scanning direction SC in accordance with the shape of the hole section 21b. Therefore, as illustrated in FIG. 9, in a case where the first movement member 21 is lifted obliquely, the fourth movement member 24 and the first movement member 21 can be smoothly connected by shifting the connection position between the fourth movement member 24 and the first movement member 21 in the main scanning direction SC.

As illustrated in FIGS. 5 and 6, the end section 24b of the fourth movement member 24 is connected to the hole section 23b provided at the end of the third movement member 23 in such a manner as to be inserted into the hole center. The hole section 23b has a shape that spreads in the main scanning direction SC. Therefore, the connection position between the fourth movement member 24 and the third movement member 23 can be slightly moved in the main scanning direction SC in accordance with the shape of the hole section 23b. Therefore, in a case where the third movement member 23 is lifted obliquely, the fourth movement member 24 and the third movement member 23 can be smoothly connected by shifting the connection position between the fourth movement member 24 and the third movement member 23 in the main scanning direction SC.

The horizontal positions of the bottom sections 21a, 22a, 23a, and 24a of the first movement member 21, the second movement member 22, the third movement member 23, and the fourth movement member 24, respectively, are adjusted in advance to be the same height position. As an example, as illustrated in FIG. 4, the bottom section 21a of the first movement member 21 and the bottom section 22a of the second movement member 22 are adjusted to the same height position H1.

As described above, the second movement member 22 is connected to the first movement member 21 and the third movement member 23. Similarly, the fourth movement member 24 is connected to the first movement member 21 and the third movement member 23. Therefore, the movement of any one of the first movement member 21, the second movement member 22, the third movement member 23, and the fourth movement member 24 in the vertical direction UP moves the other movement members in conjunction therewith. For example, when any one of the first movement member 21, the second movement member 22, the third movement member 23, and the fourth movement member 24 moves in the vertical direction UP according to the height of the upper surface of the medium W, the entire movement member moves in the vertical direction UP.

The detection section 27 detects the movement of the first movement member 21, the second movement member 22, the third movement member 23, and the fourth movement member 24 in the vertical direction UP. To be specific, the detection section 27 includes a first detection sensor 27a, a second detection sensor 27b, a third detection sensor 27c, and a fourth detection sensor 27d. As illustrated in FIGS. 2, 3, and 9, the first detection sensor 27a is a sensor that detects the amount of movement in the vertical direction UP at the connection point between the first movement member 21 and the fourth movement member 24. For example, as illustrated in FIG. 9, the first detection sensor 27a is an optical sensor that measures distances L1 and L2 from the end section 24b, which vary in accordance with the movement amounts of the first movement member 21 and the fourth movement member 24 in the vertical direction UP.

Similarly, as illustrated in FIG. 2, the second detection sensor 27b is a sensor that detects the amount of movement in the vertical direction UP at the connection point between the first movement member 21 and the second movement member 22. As illustrated in FIG. 7, the third detection sensor 27c is a sensor that detects the amount of movement in the vertical direction UP at the connection point between the third movement member 23 and the second movement member 22. As illustrated in FIG. 5, the fourth detection sensor 27d is a sensor that detects the amount of movement in the vertical direction UP at the connection point between the third movement member 23 and the fourth movement member 24.

The control section 12b determines whether or not the medium W has floated up based on the detection results of the first detection sensor 27a, the second detection sensor 27b, the third detection sensor 27c, and the fourth detection sensor 27d. For example, the control section 12b converts the distances L1 and L2 to the end section 24b detected by the first detection sensor 27a into a movement amount of the movement member in the vertical direction UP. The control section 12b similarly converts the detection results of the second detection sensor 27b, the third detection sensor 27c, and the fourth detection sensor 27d into movement amounts of the movement members in the vertical direction UP.

Next, the control section 12b determines whether or not the medium W is floating based on the amounts that the movement members move in the vertical direction UP, which were converted from the four detection results. For example, the control section 12b determines that the medium W lifted up when the maximum value of the movement amounts converted from the four detection results exceeds a predetermined value. The control section 12b may determine that the medium W lifted up when the mean value of the movement amounts converted from the four detection results exceeds a predetermined value.

When the control section 12b determines that lifting up of the medium W is present, the control section LA outputs, to the output device 13, alert information indicating that lifting up of the medium W is present. The output device 13 notifies the user of the alert information output from the control section 12b by voice or display.

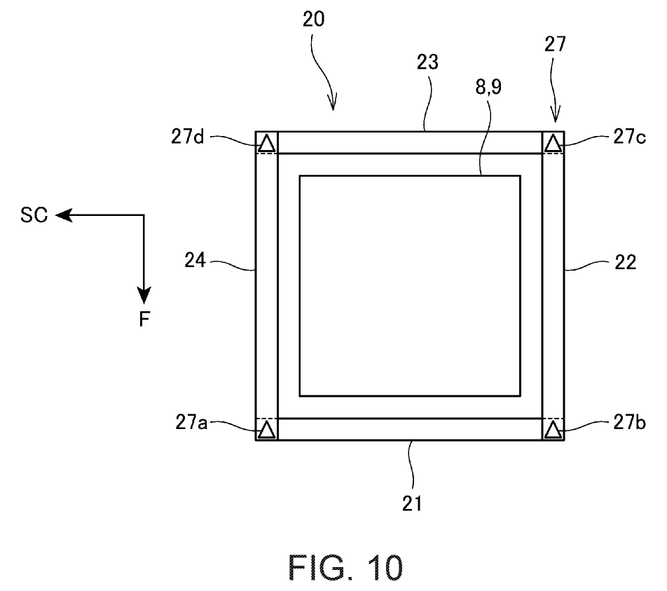

FIG. 10 is a schematic diagram of the movement section 20 and the detection section 27 of the printer 1 according to the embodiment. Note that in FIG. 10 and subsequent drawings, the positions where end sections of the first movement member 21, the second movement member 22, the third movement member 23, and the fourth movement member 24 are connected to each other are illustrated so as to overlap each other.

As illustrated in FIG. 10, the movement section 20 according to the above-described embodiment is disposed so as to surround the periphery of the carriage 8 in a square shape. Specifically, the first movement member 21, which extends in the main scanning direction SC, is disposed on the downstream side in the transport direction F. The third movement member 23, which extends in the main scanning direction SC, is disposed on the upstream side in the transport direction F. The second movement member 22, which extends in the transport direction F, is disposed on the upstream side in the main scanning direction SC. The fourth movement member 24, which extends in the transport direction F, is disposed on the downstream side in the main scanning direction SC.

The ends of the first movement member 21 are connected to the end sections of the second movement member 22 and the fourth movement member 24 that are on the downstream side in the transport direction F. The ends of the third movement member 23 are connected to the end sections of the second movement member 22 and the fourth movement member 24 that are on the upstream side in the transport direction F.

The detection section 27 performs detection in the vertical direction UP at the four corners of the movement section 20. To be specific, a first detection sensor 27a, a second detection sensor 27b, a third detection sensor 27c, and a fourth detection sensor 27d are disposed at positions corresponding to the four corners of the movement section 20. By this, in the printer 1, it is possible to reliably detect when the medium W is rising up in the region corresponding to the carriage 8.

### First Modification

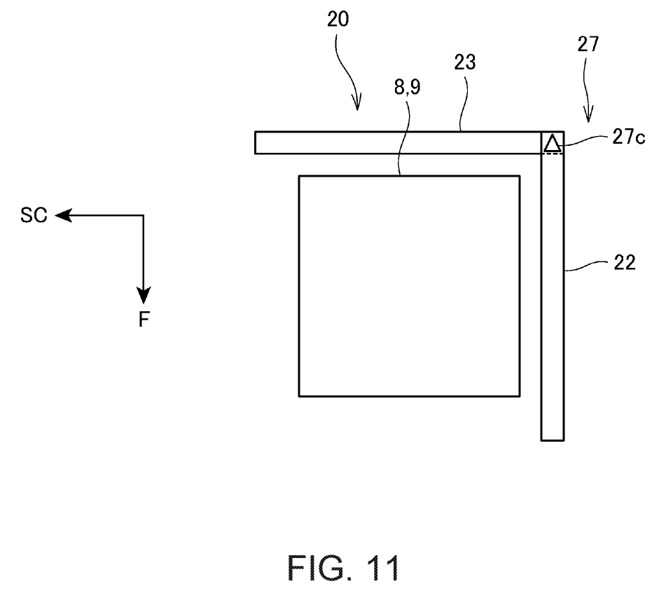

FIG. 11 is a schematic diagram of the movement section 20 and the detection section 27 of the printer 1 according to a first modification. As illustrated in a first modification of FIG. 11, the movement section 20 may be configured by a set of two movement members of the second movement member 22 extending in the transport direction F and the third movement member 23 extending in the main scanning direction SC.

Specifically, the second movement member 22 extending in the transport direction F is disposed on the upstream side of the carriage 8 in the main scanning direction SC. The third movement member 23 extending in the main scanning direction SC is disposed on the upstream side of the carriage 8 in the transport direction F. The end section of the second movement member 22 on the upstream side in the transport direction F and the end section of the third movement member 23 on the upstream side in the main scanning direction SC are connected to each other, and a third detection sensor 27c is provided.

By this, in the first modification, it is possible to detect lifting up of the medium W on the upstream side in the main scanning direction SC and in the transport direction F with respect to the region corresponding to the carriage 8.

### Second modification

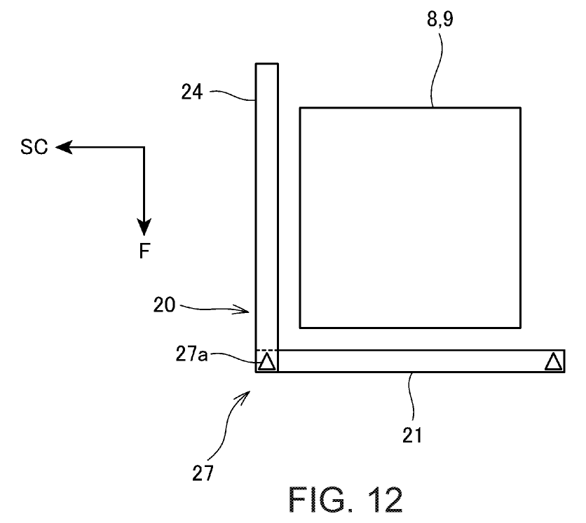

FIG. 12 is a schematic diagram of the movement section 20 and the detection section 27 of the printer 1 according to a second modification. As illustrated in the second modification of FIG. 12, the movement section 20 may be configured by a set of two movement members, that is, the fourth movement member 24, which extends in the transport direction F, and the first movement member 21, which extends in the main scanning direction SC.

Specifically, the fourth movement member 24 extending in the transport direction F is disposed on the downstream side of the carriage 8 in the main scanning direction SC. The first movement member 21 extending in the main scanning direction SC is disposed on the downstream side of the carriage 8 in the transport direction F. The end section of the fourth movement member 24 on the downstream side in the transport direction F and the end section of the first movement member 21 on the downstream side in the main scanning direction SC are connected to each other, and a first detection sensor 27a is provided.

By this, in the second modification, it is possible to detect lifting up of the medium W on the downstream side in the main scanning direction SC and the transport direction F with respect to the region corresponding to the carriage 8.

### Third modification

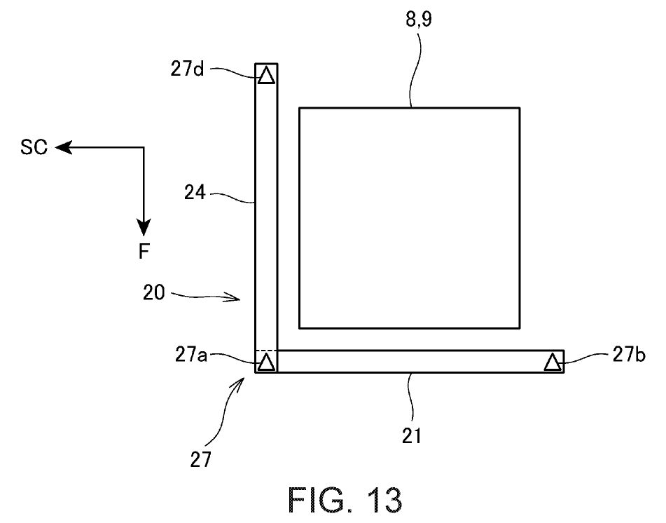

FIG. 13 is a schematic diagram of the movement section 20 and the detection section 27 of the printer 1 according to a third modification. As illustrated in FIG. 13, in the third modification, the detection section 27 is configured to detect movement in the vertical direction UP at three end sections of a movement section 20 that is similar to that of the second modification.

In detail, the first detection sensor 27a is provided at an end section where the first movement member 21 and the fourth movement member 24 are connected to each other. The second detection sensor 27b and the fourth detection sensor 27d are provided at the end sections opposite to the end section where the first movement member 21 and the fourth movement member 24 are connected to each other. By this, in the third modification, lifting up of the medium W can be detected more accurately than in the second modification.

### Fourth modification

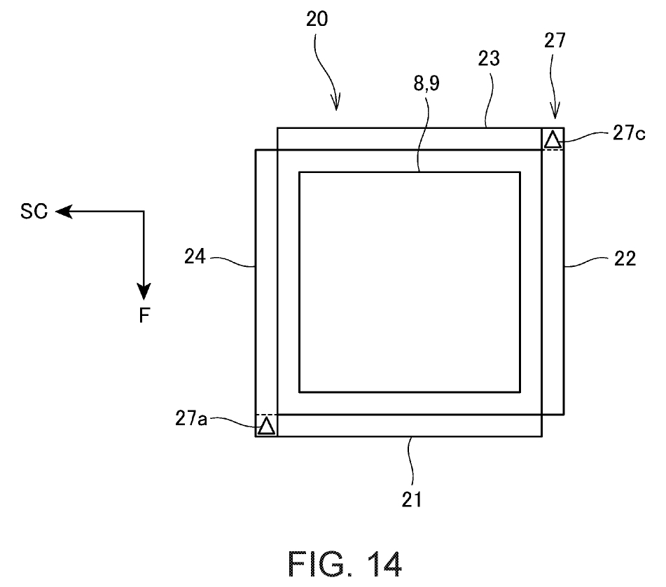

FIG. 14 is a schematic diagram of the movement section 20 and the detection section 27 of the printer 1 according to a fourth modification. As illustrated in FIG. 14, the fourth modification is a modification in which the first modification illustrated in FIG. 11 and the second modification illustrated in FIG. 12 are combined.

In the fourth modification, in the printer 1, it is possible to reliably detect lifting up of the medium W in the region corresponding to the carriage 8. In the fourth modification, the number of sensors in the detection section 27 can be reduced from four to two, compared to the above-described embodiment.

### Fifth modification

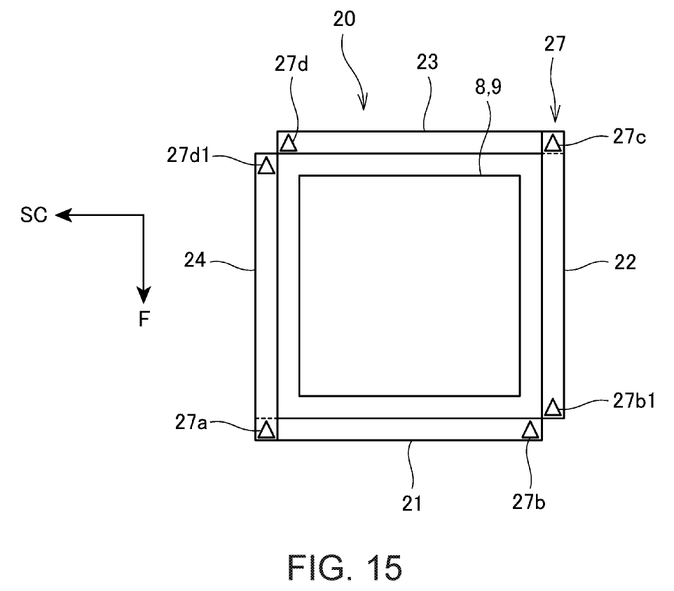

FIG. 15 is a schematic diagram of the movement section 20 and the detection section 27 of the printer 1 according to a fifth modification. As illustrated in FIG. 15, the fifth modification has a configuration in which the number of sensors in the detection section 27 is increased in a movement section 20 that is similar to that of the fourth modification.

In particular, the first detection sensor 27a is provided at an end section where the first movement member 21 and the fourth movement member 24 are connected to each other. The second detection sensor 27b and a sixth detection sensor 27d1 are provided at the end sections opposite to the end section where the first movement member 21 and the fourth movement member 24 are connected to each other. A third detection sensor 27c is provided at an end section where the third movement member 23 and the second movement member 22 are connected to each other. A fourth detection sensor 27d and a fifth detection sensor 27b1 are provided at the end sections opposite to the end section where the third movement member 23 and the second movement member 22 are connected to each other. By this, in the fifth modification, lifting up of the medium W can be detected more accurately than in the fourth modification.

### Sixth modification

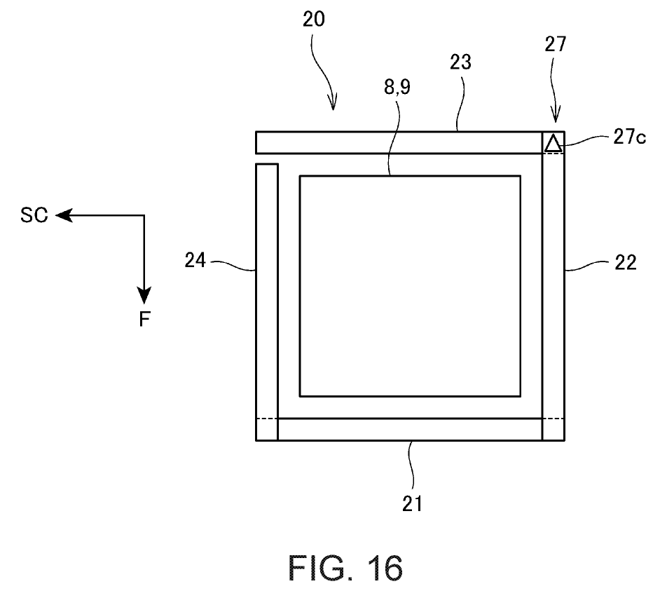

FIG. 16 is a schematic diagram of the movement section 20 and the detection section 27 of the printer 1 according to a sixth modification. As illustrated in FIG. 16, in the sixth modification, the movement section 20 is disposed so as to surround the periphery of the carriage 8 in a square shape.

Specifically, the first movement member 21, which extends in the main scanning direction SC, is disposed on the downstream side in the transport direction F. The third movement member 23, which extends in the main scanning direction SC, is disposed on the upstream side in the transport direction F. The second movement member 22, which extends in the transport direction F, is disposed on the upstream side in the main scanning direction SC. The fourth movement member 24, which extends in the transport direction F, is disposed on the downstream side in the main scanning direction SC.

The ends of the first movement member 21 are connected to the end sections of the second movement member 22 and the fourth movement member 24 that are on the downstream side in the transport direction F. The end section of the second movement member 22 on the upstream side in the transport direction F and the end section of the third movement member 23 on the upstream side in the main scanning direction SC are connected to each other, and a third detection sensor 27c is provided. The end section of the fourth movement member 24 on the upstream side in the transport direction F and the end section of the third movement member 23 on the downstream side in the main scanning direction SC are not connected to each other.

By this, in the sixth modification, lifting up of the medium W in the region corresponding to the carriage 8 can be detected with a smaller number of sensors.

As described above, the printer 1 includes the first movement member (21 and 23) that is installed at one end of the carriage 8 along the main scanning direction SC and that is movable in the vertical direction UP according to the height of the upper surface of the medium W at the installation position. The printer 1 includes the second movement member (22 and 24) that is installed at one end of the carriage 8 along the transport direction F and that is movable in the vertical direction UP according to the height of the upper surface of the medium W at the installation position. The printer 1 includes the detection section 27 that detects the movement of at least one of the first movement member and the second movement member in the vertical direction UP. The first movement member and the second movement member are connected so that one of the first movement member and the second movement member moves in conjunction with the movement of the other in the vertical direction UP.

Therefore, in the printer 1, the first movement member (21 and 23) disposed along the main scanning direction SC or the second movement member (22 and 24) disposed along the transport direction F can reliably detect lifting up of the medium W at the print position R1.

The first movement member 21 is installed at an end section of the carriage 8 on the downstream side in the relative movement direction in the transport direction F. Therefore, in the printer 1, it is possible to more reliably detect lifting up of the medium W occurring on the downstream side in the transport direction F in the carriage 8. For example, when the medium W is peeled off from the transport belt 5 after printing is performed by the print head 9 of the carriage 8, a force applied at the time of peeling off is transmitted to the vicinity of the carriage 8, and the medium W may lift up. In the printer 1, it is possible to cope with lifting up of the medium W on the downstream side in the transport direction F, which occurs when the medium W is peeled off from the transport belt 5 in this manner.

The carriage 8 is movable relative to the transport belt 5 in the main scanning direction SC, and the fourth movement member 24 is installed at the end section of the carriage 8 on the downstream side in the relative movement direction in the main scanning direction SC. Therefore, in the printer 1, it is possible to more reliably detect lifting up of the medium W that occurred on the downstream side in the main scanning direction SC in the carriage 8.

In the printer 1, the first movement member 21 and the second movement member 22 are connected to each other at their end sections. The detection section 27 detects movement in the vertical direction UP at three end sections of the first movement member 21 and the second movement member 22 whose end sections are connected to each other. By this, in the printer 1, lifting up of the medium W can be more reliably detected at the three end sections of the first movement member 21 and the second movement member 22, the end sections of which are connected to each other.

For example, in a case where the rigidity of the first movement member 21 and the second movement member 22 is high, the medium W comes into contact with the bottom section of one of the movement members, and thus both of the movement members move in the vertical direction UP without changing posture. Therefore, the detection section 27 may detect the movement of any one of the end sections of the first movement member 21 and the second movement member 22. In this case, the number of sensors in the detection section 27 can be reduced, and thus an effect of cost reduction can be obtained. However, when the rigidity of the first movement member 21 and the second movement member 22 is high, the weight thereof increases, and thus the first movement member 21 and the second movement member 22 would not move due to light contact with the medium W and the detection accuracy may decrease. In contrast, by detecting the movement in the vertical direction UP at the three end sections of the first movement member 21 and the second movement member 22, the rigidity of the first movement member 21 and the second movement member 22 can be reduced (the weight can be reduced), and detection can be performed with light contact with the medium W.

In addition to the first movement member 21 and the second movement member 22, the printer 1 includes the third movement member 23 that is installed along the main scanning direction SC and that is movable in the vertical direction UP according to the height of the upper surface of the medium W at the installation position. The printer 1 includes the fourth movement member 24 that is installed along the transport direction F and that is movable in the vertical direction UP according to the height of the upper surface of the medium W at the installation position. The printer 1 includes the detection section 27 that detects the movement of at least one of the third movement member 23 and the fourth movement member 24 in the vertical direction UP. The third movement member 23 and the fourth movement member 24 are connected such that one of the third movement member 23 and the fourth movement member 24 moves in conjunction with the movement of the other in the vertical direction UP. By this, in the printer 1, lifting up of the medium W in the region corresponding to the carriage 8 can be more reliably detected by the first movement member 21, the second movement member 22, the third movement member 23, and the fourth movement member 24.

In the printer 1, the first movement member 21 and the second movement member 22 are connected to each other at their end sections. The third movement member 23 and the fourth movement member 24 are connected to each other at their end sections. The detection section 27 detects the movement in the vertical direction UP of the three end sections of the first movement member 21 and the second movement member 22 that are connected to each other and of the three end sections of the third movement member 23 and the fourth movement member 24 that are connected to each other. Therefore, in the printer 1, lifting up of the medium W can be more reliably detected by the six end sections.

With respect to the first movement member 21, the second movement member 22, the third movement member 23, and the fourth movement member 24 of the printer 1, the first movement member 21 and the second movement member 22 are connected so that another moves in conjunction with movement of one in the vertical direction UP. The second movement member 22 and the third movement member 23 are connected to each other such that with movement in the vertical direction UP of one of the second movement member 22 and the third movement member 23, the other of the second movement member 22 and the third movement member 23 moves in conjunction. The first movement member 21 and the fourth movement member 24 are connected such that one of the first movement member 21 and the fourth movement member 24 moves in conjunction with the movement of the other in the vertical direction UP. Therefore, in the printer 1, all of the first movement member 21, the second movement member 22, the third movement member 23, and the fourth movement member 24 move in conjunction with the movement of any one of the movement members in the vertical direction UP. Therefore, in the printer 1, since the width of the detection timing in the region corresponding to the carriage 8 is widened, the detection accuracy is improved.

The first movement member 21 and the second movement member 22, the second movement member 22 and the third movement member 23, the third movement member 23 and the fourth movement member 24, and the fourth movement member 24 and the first movement member 21 are connected to each other at their respective end sections. The detection section 27 detects movement in the vertical direction UP at the four end sections where the first movement member 21, the second movement member 22, the third movement member 23, and the fourth movement member 24 are connected. Therefore, the printer 1 can more reliably detect the movement in the vertical direction UP at the rectangular detection position R2 where the first movement member 21, the second movement member 22, the third movement member 23, and the fourth movement member 24 are connected.

The printer 1 includes the pair of the first support member 25a and the second support member 25b disposed so that the first movement section (21 and 23) is interposed between them in the transport direction F. The pair of the first support member 25a and the second support member 25b guides the movement of the first movement section (21, 23) in the vertical direction UP. Therefore, in the printer 1, the first movement section (21, 23) can be protected by the pair of the first support member 25a and the second support member 25b. Therefore, for example, a member having low rigidity but a small weight can be used as the first movement section (21, 23) in the printer 1. In the printer 1, by reducing the weight of the first movement section (21, 23) in this manner, it is possible to detect the movement of the first movement section caused by from light contact with the medium W, and it is possible to improve the detection accuracy.

The printer 1 further includes the output device 13 that notifies alert information based on the detection result of the detection section 27. Therefore, in the printer 1, it is possible to reliably notify the user of an alert such as lifting up of the medium W.

### Summary of the disclosure

Hereinafter, a summary of the present disclosure is appended.

### Appendix 1

A printing device includes a medium support section that supports a medium; a printing section that performs printing on an upper surface of the medium supported by the medium support section; a print support section that supports the printing section; and a drive section that relatively moves the medium support section and the print support section in a first direction; assuming a direction intersecting the first direction is a second direction and a direction intersecting the first direction and the second direction is a third direction, a first movement section that is installed along the second direction at one end of the print support section in the first direction and that is movable in the third direction according to a height of an upper surface of the medium at an installation position; a second movement section that is installed along the first direction at one end of the print support section in the second direction and that is movable in the third direction according to the height of the upper surface of the medium at the installation position; and a first detection section that detects movement of at least one of the first movement section and the second movement section in the third direction, wherein the first movement section and the second movement section are connected such that one of the first movement section and the second movement section moves in conjunction with movement in the third direction of an other of the first movement section and the second movement section.

By this, in the printing device, lifting up of the medium in the region corresponding to the print support section can be reliably detected by the first movement section installed along the second direction or the second movement section installed along the first direction.

### Appendix 2

The printing device according to Appendix 1, wherein the first movement section is installed at an end section of the print support section on a downstream side in a direction in which the medium support section moves relative to the print support section in the first direction.

By this, in the printing device, it is possible to reliably detect floating up of the medium that occurs from the downstream side in the relative movement direction in the first direction toward the print support section.

### Appendix 3

The printing device according to appendix 1 or 2, wherein the first movement section and the second movement section are connected to each other at end sections thereof and the first detection section detects movement in the third direction at an end section where the first movement section and the second movement section are connected and at an end section opposite to the end section where the first movement section and the second movement section are connected.

By this, in the printing device, rising up of the medium can be more reliably detected at the three end sections of the first movement section and the second movement section, which are connected to each other at their end sections.

### Appendix 4

The printing device according to any one of appendices 1 to 3, wherein a third movement section that is installed along the second direction at an other end of the print support section in the first direction and that is movable in the third direction according to the height of the upper surface of the medium at the installation position and a fourth movement section that is installed along the first direction at an other end of the print support section in the second direction and that is movable in the third direction according to the height of the upper surface of the medium at the installation position; and a second detection section that detects movement in the third direction of at least one of the third movement section and the fourth movement section, wherein the third movement section and the fourth movement section are connected such that one of the third movement section and the fourth movement section moves in conjunction with movement of an other of the third movement section and the fourth movement section in the third direction.

By this, in the printing device, the medium lifting up in the region corresponding to the print support section can be more reliably detected by the first movement section, the second movement section, the third movement section, and the fourth movement section.

### Appendix 5

The printing device according to appendix 4, wherein the first movement section and the second movement section are connected to each other at end sections thereof, the first detection section detects movement in the third direction at an end section where the first movement section and the second movement section are connected and at an end section opposite to the end section where the first movement section and the second movement section are connected, the third movement section and the fourth movement section are connected to each other at end sections thereof, and the second detection section detects movement in the third direction at an end section where the third movement section and the fourth movement section are connected and at an end section opposite to the end section where the third movement section and the fourth movement section are connected.

By this, in the printing device, the medium lifting up can be more reliably detected at the three end sections of the first movement section and the second movement section, which are connected to each other, and the three end sections of the third movement section and the fourth movement section, which are connected to each other.

### Appendix 6

The printing device according to any one of appendices 1 to 3, wherein a third movement section that is installed along the second direction at an other end of the print support section in the first direction and that is movable in the third direction according to the height of the upper surface of the medium at the installation position; a fourth movement section that is installed along the first direction at an other end of the print support section in the second direction and that is movable in the third direction according to the height of the upper surface of the medium at the installation position, wherein the third movement section and the fourth movement section are connected such that one of the third movement section and the fourth movement section moves in conjunction with movement in the third direction of an other of the third movement section and the fourth movement section and the second movement section and the third movement section are connected such that one of the second movement section and the third movement section moves in conjunction with movement in the third direction of an other of the second movement section and the third movement section.

By this, in the printing device, the width of the detection timing in the region corresponding to the print support section is widened by the first movement section, the second movement section, the third movement section, and the fourth movement section, and thus the detection accuracy is improved.

### Appendix 7

The printing device according to any one of appendices 1 to 3, wherein a third movement section that is installed along the second direction at an other end of the print support section in the first direction and that is movable in the third direction according to the height of the upper surface of the medium at the installation position; a fourth movement section that is installed along the first direction at an other end of the print support section in the second direction and that is movable in the third direction according to the height of the upper surface of the medium at the installation position; and a second detection section that detects movement in the third direction of at least one of the third movement section and the fourth movement section, wherein the first movement section and the second movement section, the second movement section and the third movement section, the third movement section and the fourth movement section, and the fourth movement section and the first movement section are connected to each other at respective end sections, the first detection section detects movement in the third direction at respective end sections where the first movement section and the second movement section are connected and where the fourth movement section and the first movement section are connected, and the second detection section detects movement in the third direction at respective end sections where the second movement section and the third movement section are connected and where the third movement section and the fourth movement section are connected.

By this, in the printing device, the medium lifting up can be more reliably detected at the respective end sections where the first movement section and the second movement section are connected, the fourth movement section and the first movement section are connected, the second movement section and the third movement section are connected, and the third movement section and the fourth movement section are connected.

### Appendix 8

The printing device according to any one of appendices 1 to 7, further including a pair of plate members that are disposed so as to sandwich the first movement section in the first direction and that guide movement of the first movement section in the third direction.

By this, in the printing device, the first movement section can be protected by the pair of plate members. Therefore, in the printing device, a first movement section having low rigidity but small weight can be used, and the medium lifting up in the first movement section can be more reliably detected.

### Appendix 9

The printing device according to any one of appendices 1 to 8, further including a notification section that notifies alert information based on a detection result of the detection section.

By this, in the printing device, it is possible to reliably notify the user of an alert such as the medium lifting up.

What is claimed is:

1. A printing device comprising:
a medium support section that supports a medium;
a printing section that performs printing on an upper surface of the medium supported by the medium support section;
a print support section that supports the printing section; and
a drive section that relatively moves the medium support section and the print support section in a first direction;
assuming a direction intersecting the first direction is a second direction and a direction intersecting the first direction and the second direction is a third direction,
a first movement section that is installed along the second direction at one end of the print support section in the first direction and that is movable in the third direction according to a height of an upper surface of the medium at an installation position;
a second movement section that is installed along the first direction at one end of the print support section in the second direction and that is movable in the third direction according to the height of the upper surface of the medium at the installation position; and
a first detection section that detects movement of at least one of the first movement section and the second movement section in the third direction, wherein
the first movement section and the second movement section are connected such that one of the first movement section and the second movement section moves in conjunction with movement in the third direction of an other of the first movement section and the second movement section.

2. The printing device according to claim 1, wherein
the first movement section is installed at an end section of the print support section on a downstream side in a direction in which the medium support section moves relative to the print support section in the first direction.

3. The printing device according to claim 1, wherein
the first movement section and the second movement section are connected to each other at end sections thereof and
the first detection section detects movement in the third direction at an end section where the first movement section and the second movement section are connected and at an end section opposite to the end section where the first movement section and the second movement section are connected.

4. The printing device according to claim 1, further comprising:
a third movement section that is installed along the second direction at an other end of the print support section in the first direction and that is movable in the third direction according to the height of the upper surface of the medium at the installation position;
a fourth movement section that is installed along the first direction at an other end of the print support section in the second direction and that is movable in the third direction according to the height of the upper surface of the medium at the installation position; and
a second detection section that detects movement in the third direction of at least one of the third movement section and the fourth movement section, wherein
the third movement section and the fourth movement section are connected such that one of the third movement section and the fourth movement section moves in conjunction with movement of an other of the third movement section and the fourth movement section in the third direction.

5. The printing device according to claim 4, wherein
the first movement section and the second movement section are connected to each other at end sections thereof,
the first detection section detects movement in the third direction at an end section where the first movement section and the second movement section are connected and at an end section opposite to the end section where the first movement section and the second movement section are connected,
the third movement section and the fourth movement section are connected to each other at end sections thereof, and
the second detection section detects movement in the third direction at an end section where the third movement section and the fourth movement section are connected and at an end section opposite to the end section where the third movement section and the fourth movement section are connected.

6. The printing device according to claim 1, further comprising:
a third movement section that is installed along the second direction at an other end of the print support section in the first direction and that is movable in the third direction according to the height of the upper surface of the medium at the installation position and
a fourth movement section that is installed along the first direction at an other end of the print support section in the second direction and that is movable in the third direction according to the height of the upper surface of the medium at the installation position, wherein
the third movement section and the fourth movement section are connected such that one of the third movement section and the fourth movement section moves in conjunction with movement in the third direction of an other of the third movement section and the fourth movement section and
the second movement section and the third movement section are connected such that one of the second movement section and the third movement section moves in conjunction with movement in the third direction of an other of the second movement section and the third movement section.

7. The printing device according to claim 1, further comprising:
a third movement section that is installed along the second direction at an other end of the print support section in the first direction and that is movable in the third direction according to the height of the upper surface of the medium at the installation position;
a fourth movement section that is installed along the first direction at an other end of the print support section in the second direction and that is movable in the third direction according to the height of the upper surface of the medium at the installation position; and
a second detection section that detects movement in the third direction of at least one of the third movement section and the fourth movement section, wherein
the first movement section and the second movement section, the second movement section and the third movement section, the third movement section and the fourth movement section, and the fourth movement section and the first movement section are connected to each other at respective end sections,
the first detection section detects movement in the third direction at respective end sections where the first movement section and the second movement section are connected and where the fourth movement section and the first movement section are connected, and
the second detection section detects movement in the third direction at respective end sections where the second movement section and the third movement section are connected and where the third movement section and the fourth movement section are connected.

8. The printing device according to claim 1, further comprising:
a pair of plate members that are disposed so as to sandwich the first movement section in the first direction and that guide movement of the first movement section in the third direction.

9. The printing device according to claim 1, further comprising:
a notification section that notifies alert information based on a detection result of the detection section.
